(19) United States
(12) Patent Application Publication
(10) Pub. No.: US 2022/0043588 A1
(43) Pub. Date: Feb. 10, 2022

(54) LOCALIZED MEMORY TRAFFIC CONTROL FOR HIGH-SPEED MEMORY DEVICES

(71) Applicant: MICRON TECHNOLOGY, INC., Boise, ID (US)

(72) Inventors: Jian HUANG, Union City, CA (US); Zhenming ZHOU, San Jose, CA (US)

(21) Appl. No.: 16/987,124

(22) Filed: Aug. 6, 2020

(51) Int. Cl. G06F 3/06; G06F 9/48; G06F 9/30

(52) U.S. Cl. CPC G06F 3/0631; G06F 3/0644; G06F 3/0659; G06F 3/0647; G06F 9/3009; G06F 3/0617; G06F 3/0679; G06F 9/4881; G06F 3/0653

(57) ABSTRACT

A processing device receives a series of commands associated with a memory device. The memory device includes memory cells that are distributed among multiple planes. The processing device identifies a respective plane to which each command is directed, and places a respective set of commands directed to the respective plane in a corresponding queue associated with the respective plane. A first set of commands placed in a first queue associated with a first plane are processed first. Responsive to determining that a predetermined criterion is satisfied, a second set of commands placed in a second queue associated with a second plane are processed. To minimize having to switch between different planes while responding to read/write commands, wear-leveling is restricted to each plane using overprovisioning capacity in each plane.

### TECHNICAL FIELD

Embodiments of the present disclosure relate generally to a memory sub-system, and more specifically, relate to controlling memory traffic intelligently in a localized manner within a memory device in the memory sub-system to minimize switching between various planes of the memory device.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various implementations of the disclosure.

FIG. 1 illustrates an example computing system that includes a host system coupled with a memory sub-system in accordance with some embodiments of the present disclosure.

FIG. 2 illustrates the concept of command-grouping for write/read commands that are initiated by a host and directed to different planes of a memory device, in accordance with some embodiments of the present disclosure.

FIG. 3 illustrates a flow diagram of an example method of implementing host command-grouping, in accordance with some embodiments of the present disclosure.

FIG. 4A illustrates use of over-provisioning during wear-leveling involving two planes, in accordance with some embodiments of the present disclosure.

FIG. 4B illustrates restricting over-provisioning and wear-leveling within a single plane, in accordance with some embodiments of the present disclosure.

FIG. 5 illustrates a flow diagram of an example method of combining over-provisioning and wear-leveling for minimizing switching between multiple planes, in accordance with some embodiments of the present disclosure.

FIG. 6 illustrates a block diagram of an example computer system in which implementations of the present disclosure can operate.

### DETAILED DESCRIPTION

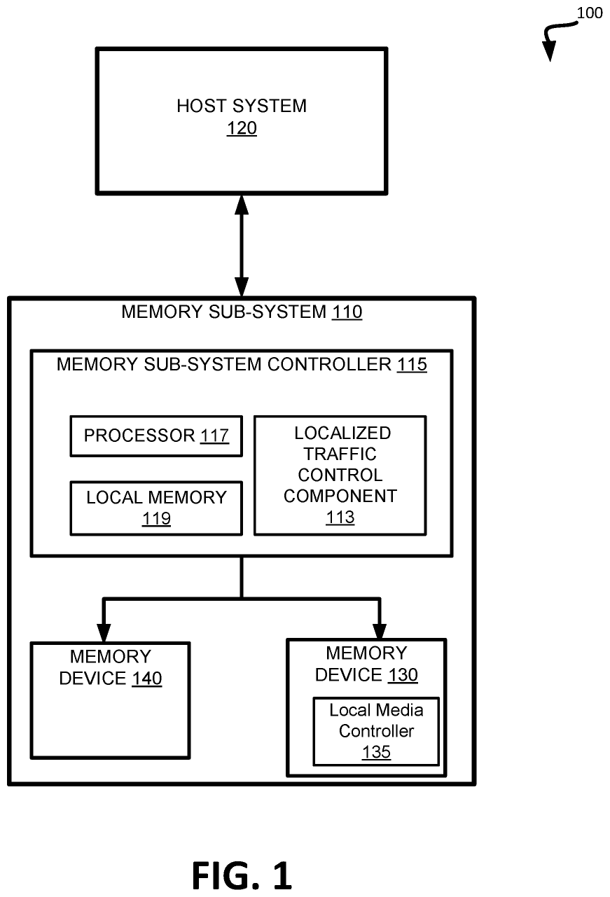

Aspects of the present disclosure are directed to intelligent localized control of command and data traffic between various planes of a multi-plane memory device for avoiding potential loss of signal integrity and power distribution limitation in the memory device. A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a negative-and (NAND) memory device. Another example is a three-dimensional cross-point (“3D cross-point”) memory device that includes an array of non-volatile memory cells. A 3D cross-point memory device can perform bit storage based on a change of bulk resistance, in conjunction with a stackable cross-gridded data access array. Other examples of non-volatile memory devices are described below in conjunction with FIG. 1. A non-volatile memory device is a package of one or more dies. Each die can consist of one or more planes. For some types of non-volatile memory devices (e.g., NAND devices), each plane consists of a set of physical blocks. Each block consists of a set of pages. Each page consists of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can be made up of bits arranged in a two-dimensional grid or even three-dimensional grids to increase storage density. Memory cells are formed on a silicon wafer in an array of columns (also hereinafter referred to as bitlines (BLs)) and rows (also hereinafter referred to as wordlines (WLs)). A wordline can refer to one or more rows of memory cells of a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form a plane of the memory device in order to allow concurrent operations to take place on each plane. A 3D cross point memory device (along with its controller) is referred to as a “drive”, which has multiple dies layered in multiple planes known as “decks.” Note than the terms “planes”, “layers” and “decks” are used interchangeably in the context of 3D cross point memory devices.

In a multi-plane memory device, there is usually command and/or data traffic across various planes. For example, a host computer system can request data to be written to or read from different physical locations of the memory device which can be distributed among various planes. Additionally, a mechanism called “wear-leveling” is often employed to prolong the life of the memory cells across the planes. Wear-leveling can be part of a periodic maintenance process, which is often executed by a firmware of a memory controller in certain advanced memory devices.

In conventional memory sub-systems, wear-leveling is done at a device-level, e.g., drive-level in a 3D cross point memory device. This device-level wear-leveling can involve certain segments of data to be moved from one plane to another. For example, if the memory cells in a first plane is over-utilized and the memory cells in the second plane are under-utilized, then the memory cells in the first plane are in danger of wearing out much more rapidly than the memory cells in the second plane. This can lead to uneven performance from deck to deck, and can result in a low reliability rating for the drive. To avoid this potential reliability problem, conventional memory sub-systems periodically run a background thread to limit number of write cycles per cell, and/or move segments of data from one cell to another cell so that number of read cycle per cell is limited. Segments of data are often moved from one plane to another plane to evenly distribute wear of the memory cells. The background thread is a process that can run when memory cells are not actively being programmed or used to process a read/write command.

However, this conventional wear-leveling across all the planes at a device level introduces new problems, especially in high-speed memory devices, such 3D cross point and NAND based memory devices. High-speed switching between planes to access various segments of data encounter power and/or signal integrity limitations intrinsically associated with physical design of the electronic circuit components handling high-frequency signals. This can result in failure during high speed read/write operations.

Aspects of the present disclosure address the above and other deficiencies by localizing command and/or data traffic at individual planes as much as possible, i.e., minimizing the need to switch between various planes of a memory device. The memory sub-system achieves this by grouping incoming read/write command based on an associated plane and prioritizing command executions by planes. Additionally, the memory sub-system performs wear leveling within each plane rather than at a device-level involving multiple planes. The memory sub-system allocates excess storage capacity (referred to as “overprovisioning”, abbreviated as OP) in each plane so that during wear-leveling, segments of data can be moved from an initial location to an OP location within the same plane rather than having to be moved to a completely different plane.

Advantages of the present disclosure include, but are not limited to, minimizing possible negative impact of plane-switching (e.g., “deck-switching” in 3D cross point devices) that can lead to data read/write failures during high-speed operations in advanced memory devices. The power/signal design of the electronic circuit does not have to be changed when a memory controller runs the algorithms disclosed here to minimize the need for plane-switching.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include negative-and (NAND) type flash memory and write-in-place memory, such as a three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs, or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can be a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA) namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, a memory device 130 is a managed memory device, which is a raw memory device combined with a local controller (e.g., local controller 135) for media management within the same memory device package. An example of a managed memory device is a managed NAND (MNAND) device.

The memory sub-system 110 can additionally include a local traffic control component 113 that can be used to facilitate the operations for the memory devices 130. The operations include transferring data from a host to the memory device during the write cycles, and transferring data from the memory device to the host for the read cycles. Specifically, the local traffic control component 113 shown in FIG. 1 can run algorithms to ensure that the need to switch between various planes of a memory device is minimized while catering to host-initiated commands. In some embodiments, the local traffic control component 113 may be part of a memory sub-system 110 having one or more memory devices 130. In those embodiments, the local traffic control component 113 can dynamically change memory management parameters for the memory devices 130 based on a level of wearing during the memory device's operational lifetime. In some embodiments, the memory sub-system controller 115 includes at least a portion of local traffic control component 113. For example, the memory sub-system controller 115 can include a processor 117 (processing device) configured to execute instructions stored in local memory 119 for performing the operations described herein. In some embodiments, local traffic control component 113 is part of the host system 110, an application, or an operating system. In other embodiment, local media controller 135 includes at least a portion of local traffic control component 113 and is configured to perform the functionality described herein. Further details with regards to the operations of the local traffic control component 113 are described below.

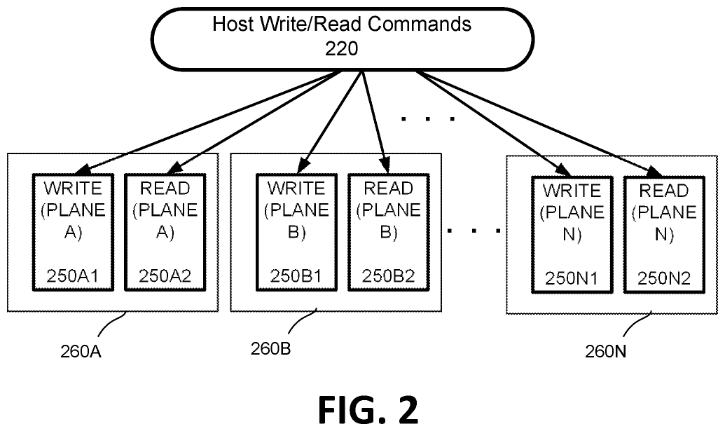

FIG. 2 illustrates memory access commands (e.g., write/read commands) 220 initiated by a host system 120 that the memory sub-system 110 determines to be directed to different planes, e.g., plane A, plane B, . . . plane N. The memory sub-system can store information that maps the one or more logical addresses of the memory device with corresponding physical addresses of the memory cells in the memory device. A processing device in the memory sub-system 110 can identify the respective planes associated with the corresponding memory cells based on the mapping of the logical addresses to the physical addresses.

FIG. 2 also illustrates the concept of command-grouping for minimizing switching between multiple planes, in accordance with some embodiments of the present disclosure. A memory sub-system can receive multiple commands that are determined to be directed to various planes. The local traffic control component 113 groups all commands directed to plane A in queue 260A, all commands directed to plane B in queue 260B, and so on. In general, all commands directed to a particular plane are grouped together. Each queue can have one or more read commands, write commands or both. For example, queue 260A can have write command(s) 250A1 directed towards plane A and read command(s) 250A2 directed towards plane A. Similarly queue 260N can have write command(s) 250N1 directed towards plane N and read command(s) 250N2 directed towards plane N.

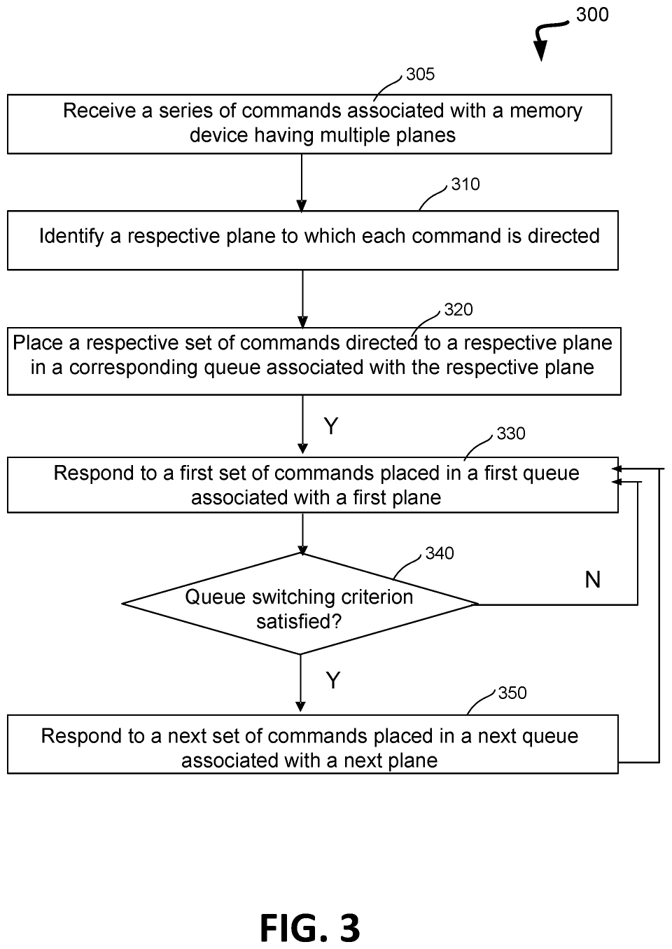

FIG. 3 is a flow diagram of an example method 300 of localized traffic control based on command-grouping, in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 can be performed by local traffic control component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

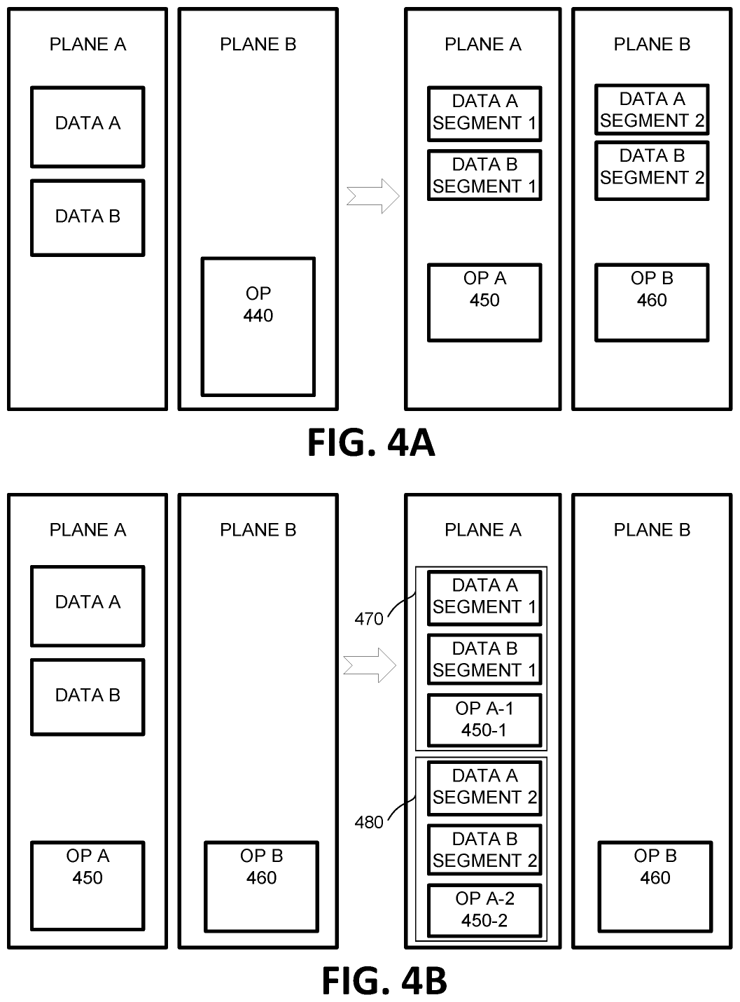

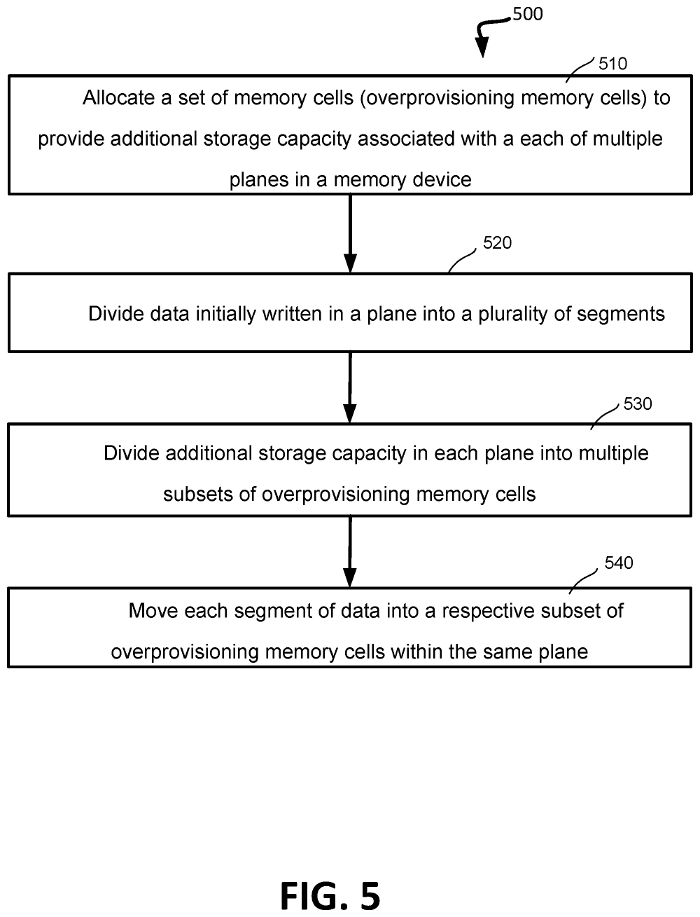

At operation 305, a local traffic control component 113 receives a series of commands that specify one or more memory addresses in the memory device. The commands can be host-initiated read/write commands in some embodiments, as shown in the block diagram of FIG. 2. In some other embodiments, the commands can be initiated by a background thread executed by the firmware of the memory sub-system 110 itself. An example of firmware-initiated command can be to initiate wear-leveling operations, as described with respect to the block diagrams in FIGS. 4A-4B and method 500 in FIG. 5. The memory addresses can be associated with particular memory cells. The memory cells can be in one plane or can be distributed in multiple planes.

At operation 310, a processing device associated with the local traffic control component 113 identifies respective planes for each of the commands are directed to. The memory sub-system can inspect the command and determine which plane the command is directed to based on a stored database mapping each memory address with its corresponding physical plane. For example, the memory address can be logical address (such as a logical block address (LBA)) which has a corresponding physical address in the memory device, and the memory sub-system can determine which physical plane the physical address of the memory cell belongs to.

Responsive to identification of the planes, at operation 320, the local traffic control component 113 place respective sets of commands directed to respective planes in corresponding queues for those respective planes, as shown in FIG. 2. This queuing is done in order to minimize having to switch between the multiple planes, even if the result is processing the incoming commands out-of-order, as described in operations 330-350. Note that in certain cases, it is not possible to completely avoid switching between multiple planes. The local traffic control component 113 can run an algorithm that performs the plane-switching in the most efficient manner without compromising the high-speed capability of the memory device, i.e. without causing power/signal integrity loss due to fast switching between the planes.

At operation 330, the local traffic control component 113 starts responding to the set of commands in the queue for the first plane, while the commands in the other queues wait. The operations continue until a predetermined criterion for queue switching is satisfied at operation 340. For example, the criterion at operation 340 can be based on checking relative lengths of different queues. If a queue length for a particular plane is relatively longer than the queue length of other planes, then the commands in the longest queue may be processed first. Another criterion can be checking whether a particular queue is empty before switching to a next queue. Alternatively, the criterion can be a based on a threshold number of commands in the respective queues. The threshold numbers can be different for different queues or can be same for more than one queues. As an example, after a threshold number of commands directed to a first plane is processed, the operation can switch to processing commands directed to a different plane. The queue switching criterion can also be a combination of one or more of the above criteria.

At operation 350, responsive to determining that the queue-switching criterion has been satisfied, the local traffic control component 113 switches to processing commands in the next queue. The next queue can have commands directed to a plane which is different from the plane associated with the first queue. This operation is repeated until all the commands are catered to.

FIG. 4A illustrates use of over-provisioning during wear-leveling involving two planes, in accordance with some embodiments of the present disclosure. As mentioned above, over-provisioning (abbreviated as OP) assigns additional storage capacity in memory devices. After assembling a memory device, the manufacturer can assign an additional percentage of the total capacity of the memory device to over-provisioning (OP) when programming the firmware of a memory sub-system. Over-provisioning not only improves performance but often increases the life of the memory device. With more space available to the memory controller and less load per memory cell, less wear happens in the memory cells over a lifetime of a memory device, which leads to higher endurance of the memory device. In the example embodiment shown in FIG. 4A, the entire OP cells 440 can be initially assigned in plane B, while data is written at/read from plane A. After certain time of usage of the memory device, due to wear-leveling, some segments of data can become scattered across the memory device in multiple planes. For example, data A and data B were initially entirely on plane A, but after wear-leveling, a first segment of data A (segment 1) can be in plane A, while a second segment of data A (segment 2) can be in plane B. Similarly, data B can also be fragmented into segment 1 and segment 2 in plane A and plane B respectively. The OP 440 can also get redistributed among various planes, e.g., OP A 450 in plane A and OP B 460 in plane B. Note that though just two planes A and B are shown for simplicity, the redistribution of data and OP can happen across more than two planes. Whenever there are data segments distributed among more than one planes, the need for switching between the planes arises to process read/write commands. As described above, plane-switching can lead to signal/power integrity loss especially in high-speed memory, unless the hardware design is changed.

FIG. 4B illustrates restricting over-provisioning and wear-leveling within a single plane, in accordance with some embodiments of the present disclosure. Here, even if Data A and data B are fragmented after wear-leveling, different segments of the data remain within the same plane. In other words, wear-leveling is performed at a plane level, and not at a device level. The initial OP A 450 for plane A can be redistributed among one or more partitions within the same plane. For example, OP A can be redistributed as OP A-1 (450-1) for a first partition 470 of plane A and OP A-2 (450-2) for a second partition 480 of plane A. In FIG. 4B, Segment 1 of Data A, segment 1 of Data B and OP A-1 belong to a first partition 470 of plane A, and Segment 2 of Data A, segment 2 of Data B and OP A-2 belong to a second partition 480 of plane A. Similar wear-leveling operations can take place within plane B (not shown in the figure for improved clarity) for segments of data that are initially written at memory addresses associated with plane B.

FIG. 5 is a flow diagram of an example method 500 of combining over-provisioning and wear-leveling for minimizing switching between multiple planes, in accordance with some embodiments of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 can be performed by a processing device in firmware of the memory sub-system coupled to the local traffic control component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 510, a memory controller allocates a set of memory cells (OP cells) to provide additional storage capacity in each plane among the multiple planes of a memory device. The additional storage capacity is provided by memory cells earmarked for overprovisioning, i.e., those memory cells are not used initially for writing data, but are reserved for special processes, such as wear-leveling. This is elaborated below.

At operation 520, a processing device associated with a local traffic control component 113 divides data initially written to one plane into one or more segments. This segmentation can be based on a determination made by a wear-leveling algorithm. Note that data was initially not stored in the OP cells in the plane. But wear-leveling algorithms can determine that certain segments of the data can be moved to a different location and utilize the OP cells for that purpose.

At operation 530, responsive to the determination of redistribution need at operation 520, the local traffic control component 113 can divide the OP cells in a plane into multiple subsets of OP cells. At operation 540, the local traffic control component 113 moves each segment of data into a respective subset of OP cells within the same plane. In other words, the subsets of OP cells are used to redistribute one or more segments of the data within one plane instead of moving those segments to a different plane. Each subset of OP cells can be in a partition within the plane, wherein each partition can have a segment of data. This operation is illustrated and described in FIG. 4B. This operation can be executed as a background thread by the memory controller as part of scheduled maintenance of the memory device. Because of this restrictive redistribution during wear-leveling, chances of cross-plane operation are reduced during processing a subsequent read/write command coming from the host system.

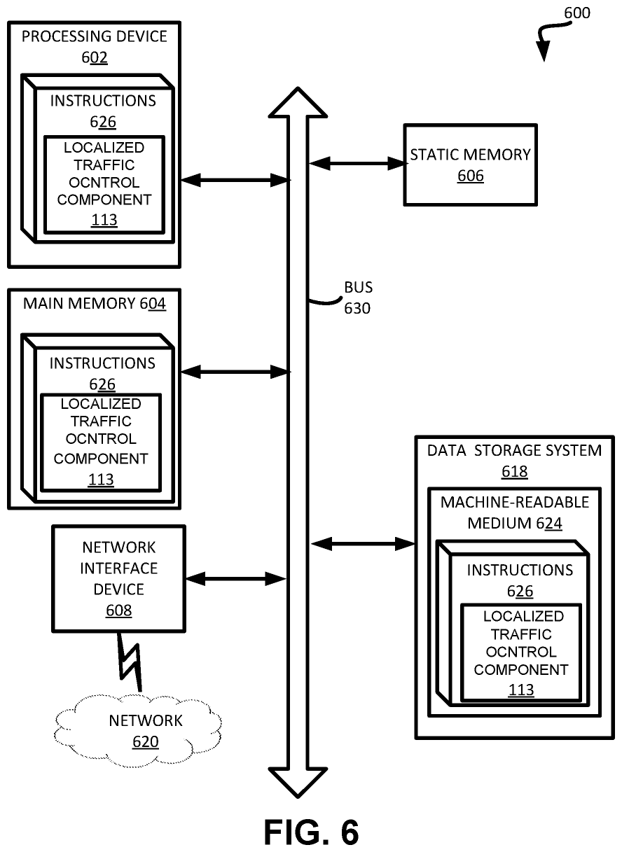

FIG. 6 illustrates an example machine of a computer system 600 within which a set of instructions, for causing the machine to perform any one or more of the methodologies discussed herein, can be executed. For example, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the local traffic control component 113 of FIG. 1). In alternative implementations, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage device 618, which communicate with each other via a bus 630.

Processing device 602 represents one or more general-purpose processing devices such as a microprocessor, a central processing unit, or the like. More particularly, the processing device can be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620. The data storage device 618 can include a machine-readable storage medium 624 (also known as a computer-readable medium) on which is stored one or more sets of instructions or software 626 embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage device 618, and/or main memory 604 can correspond to the memory sub-system 110 of FIG. 1.

In one implementation, the instructions 626 include instructions to implement functionality corresponding to a specific component (e.g., local traffic control component 113 of FIG. 1). While the machine-readable storage medium 624 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving” or “servicing” or “issuing” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus can be specially constructed for the intended purposes, or it can comprise a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing specification, implementations of the disclosure have been described with reference to specific example implementations thereof. It will be evident that various modifications can be made thereto without departing from the broader spirit and scope of implementations of the disclosure as set forth in the following claims. The specification and drawings are, accordingly, to be regarded in an illustrative sense rather than a restrictive sense.

What is claimed is:

1. A method, comprising:
receiving, by a processing device, a plurality of commands associated with a memory device, wherein the memory device comprises a plurality of memory cells that are distributed among a plurality of planes;
identifying, by the processing device, a respective plane of the plurality of planes to which each command of the plurality of commands is directed; and
placing, the processing device, a respective set of commands of the plurality of commands directed to the respective plane in a corresponding queue associated with the respective plane;
responding to a first set of commands placed in a first queue associated with a first plane of the plurality of planes; and
responsive to determining, by the processing device, that a predetermined criterion is satisfied, responding to a second set of commands placed in a second queue associated with a second plane of the plurality of planes.

2. The method of claim 1, wherein receiving the command further comprises at least one of:
receiving a write command specifying one or more logical addresses associated with corresponding memory cells of the plurality of cells where data is to be stored, or receiving a read command specifying one or more logical addresses associated with corresponding memory cells of the plurality of memory cells from which stored data is to be retrieved.

3. The method of claim 2, wherein the processing device identifies the respective planes associated with the corresponding memory cells based on the one or more logical addresses.

4. The method of claim 3, wherein the processing device identifies the respective planes associated with the corresponding memory cells from stored information that maps the one or more logical addresses with corresponding physical addresses of the memory cells.

5. The method of claim 1, wherein determining that the predetermined criterion is satisfied comprises at least one of determining that the first queue is empty, or determining that a threshold number of commands in the first queue has been responded to.

6. The method of claim 5, wherein the predetermined criterion depends on relative lengths of respective queues associated with the respective planes.

7. The method of claim 1, wherein the processing device receives the plurality of commands from a host.

8. A system comprising:
a memory device comprising a plurality of memory cells that are distributed among a plurality of planes; and
a processing device, operatively coupled to the memory device, to perform operations comprising:
allocating respective sets of memory cells to provide additional storage capacity associated with each plane of the plurality of planes, wherein the respective sets of memory cells that provide the additional storage capacity are initially reserved;
dividing data initially written in a first plane of the of the plurality of planes into a plurality of segments;
dividing a first set of memory cells providing additional storage capacity in the first plane into a first subset and a second subset of memory cells;
moving a first segment of the plurality of segments of the data initially written in the first plane to the first subset in the first plane; and
moving a second segment of the plurality of segments of the data initially written in the first plane to the second subset in the first plane.

9. The system of claim 8, wherein each plane comprises a plurality of partitions, each respective partition being associated with a respective subset of memory cells to provide the additional storage capacity in the respective partition.

10. The system of claim 9, wherein moving the second segment of the data to the second subset in the first plane further comprises:
copying the second segment of the data initially written in a first partition of the plurality of partitions to the second subset of memory cells that provide the additional storage capacity in a second partition of the plurality of partitions.

11. The system of claim 10, further comprising determining to redistribute at least a portion of the data among the plurality of partitions of the first plane during a maintenance process for the memory device.

12. The system of claim 11, wherein the maintenance process comprises a wear-leveling process for the memory device.

13. The system of claim 12, wherein the maintenance process is executed by the processing device as a background thread.

14. The system of claim 8, wherein the processing device is to perform operations further comprising:
dividing data initially written in a second plane of the of the plurality of planes into a second plurality of segments;
dividing a second set of memory cells providing additional storage capacity in the second plane into a third subset and a fourth subset of memory cells;
moving a first segment of the second plurality of segments of the data initially written in the second plane to the third subset in the second plane; and
moving a second segment of the second plurality of segments of the data initially written in the second plane to the fourth subset in the second plane.

15. A non-transitory computer readable medium comprising instructions, which when executed by a processing device, cause the processing device to perform operations comprising:
receiving, by the processing device, a plurality of commands associated with a memory device, wherein the memory device comprises a plurality of memory cells that are distributed among a plurality of planes;
identifying, by the processing device, a respective plane of the plurality of planes to which each command of the plurality of commands is directed; and
placing, by the processing device, a respective set of commands of the plurality of commands directed to the respective plane in a corresponding queue associated with the respective plane;
responding to a first set of commands placed in a first queue associated with a first plane of the plurality of planes; and
responsive to determining, by the processing device, that a predetermined criterion is satisfied, responding to a second set of commands placed in a second queue associated with a second plane of the plurality of planes.

16. The non-transitory computer readable medium of claim 15, wherein receiving the command further compriss at least one of:
receiving a write command specifying one or more logical addresses associated with corresponding memory cells of the plurality of cells where data is to be stored, or receiving a read command specifying one or more logical addresses associated with corresponding memory cells of the plurality of memory cells from which stored data is to be retrieved.

17. The non-transitory computer readable medium of claim 16, wherein the processing device identifies the respective planes associated with the corresponding memory cells based on the one or more logical addresses.

18. The non-transitory computer readable medium of claim 17, wherein the processing device identifies the respective planes associated with the corresponding memory cells from stored information that maps the one or more logical addresses with corresponding physical addresses of the memory cells.

19. The non-transitory computer readable medium of claim 15, wherein determining that the predetermined criterion is satisfied comprises at least one of determining that the first queue is empty, or determining that a threshold number of commands in the first queue has been responded to.

20. The non-transitory computer readable medium of claim 19, wherein the predetermined criterion depends on relative lengths of respective queues associated with the respective planes.
